(19) United States
(12) Patent Application Publication
(10) Pub. No.: US 2018/0352263 A1
(43) Pub. Date: Dec. 6, 2018

(54) METHOD AND DEVICE FOR PROCESSING COLOR IMAGE DATA REPRESENTING COLORS OF A COLOR GAMUT

(71) Applicant: THOMSON Licensing, Issy-les-Moulineaux (FR)

(72) Inventors: Edouard FRANCOIS, Bourg des Comptes (FR); Patrick LOPEZ, Livré sur Changeon (FR); Yannick OLIVIER, Thorigné Fouillard (FR)

(21) Appl. No.: 15/571,818

(22) PCT Filed: May 17, 2016
(86) PCT No.: PCT/EP2016/060951

§ 371 Date: Nov. 3, 2017

(30) Foreign Application Priority Data
May 18, 2015 (EP) 15305743.5
Sep. 15, 2015 (EP) 15306416.7

(51) Int. Cl. H04N 19/85; H04N 19/186

(52) U.S. Cl. CPC H04N 19/85; H04N 19/186

(57) ABSTRACT

The present principles proposes an invertible and low complexity inverse gamut mapper that preserves invariance of colors near the white point.

### 1. FIELD

The present disclosure generally relates to color gamut mapping.

### 2. BACKGROUND

The present section is intended to introduce the reader to various aspects of art, which may be related to various aspects of the present disclosure that are described and/or claimed below. This discussion is believed to be helpful in providing the reader with background information to facilitate a better understanding of the various aspects of the present disclosure. Accordingly, it should be understood that these statements are to be read in this light, and not as admissions of prior art.

In the following, a picture contains one or several arrays of color image data in a specific picture/video format which specifies all information relative to the pixel values of a picture (or a video) and all information which may be used by a display and/or any other device to visualize and/or decode a picture (or video) for example. A picture comprises at least one component, in the shape of a first array of color image data, usually a luma (or luminance) component, and, possibly, at least one other component, in the shape of at least one other array of color image data, usually a color component. Or, equivalently, the same information may also be represented by a set of arrays of color image data, such as the traditional tri-chromatic RGB representation.

A dynamic range is defined as the ratio between the minimum and maximum luminance of picture/video signal. The luminance (or brightness) is commonly measured in candela per square meter (cd/m²) or nits and corresponds to the luminous intensity per unit area of light travelling in a given direction. Dynamic range is also measured in terms of ‘f-stop’, where one f-stop corresponds to a doubling of the signal dynamic range. High Dynamic Range (HDR) generally corresponds to more than 16 f-stops. Levels in between 10 and 16 f-stops are considered as ‘Intermediate’ or ‘Extended’ dynamic range (EDR).

Current video distribution environments provide Standard Dynamic Range (SDR), typically supporting a range of brightness (or luminance) of around 0.1 to 100 cd/m², leading to less than 10 f-stops. The intent of HDR color image data is therefore to offer a wider dynamic range, closer to the capacities of the human vision.

Another aspect for a more realistic experience is the color dimension, which is conventionally defined by a color gamut. A color gamut is a certain set of colors. The most common usage refers to a set of colors which can be accurately represented in a given circumstance, such as within a given color space or by a certain output device.

A color gamut is defined by its color primaries and its white point.

Since the human eye has three types of color sensors that respond to different ranges of wavelengths, a full plot of all visible colors is a three-dimensional figure. However, the concept of color can be divided into two parts: brightness and chromaticity. For example, the color white is a bright color, while the color grey is considered to be a less bright version of that same white. In other words, the chromaticity of white and grey are the same while their brightness differs.

The CIE XYZ color space was deliberately designed so that the Y parameter was a measure of the brightness (or luminance) of a color. The chromaticity of a color was then specified by the two derived parameters x and y, two of the three normalized values which are functions of all three tristimulus values X, Y, and Z:

$$\begin{matrix}x = \frac{X}{X + Y + Z} \\ y = \frac{Y}{X + Y + Z} \\ z = \frac{Z}{X + Y + Z} = 1 - x - y\end{matrix}$$

The derived color space specified by x, y, and Y is known as the CIE 1931 xyY color space and is widely used to specify colors and color gamuts in practice.

The X and Z tristimulus values can be calculated back from the chromaticity values x and y and the Y tristimulus value:

$$\begin{matrix}X = \frac{Y}{y} x \\ Z = \frac{Y}{y} ( 1 - x - y )\end{matrix}$$

FIG. 1 shows a CIE 1931 xy chromaticity diagram obtained as explained above. The outer curved boundary SL is the so-called spectral locus, (delimited by the tongue-shaped or horseshoe-shaped area), representing the limits of the natural colors.

It is usual that a representation of a color gamut in a chromaticity diagram is delimited by a polygon joining the color primaries defined in a chromaticity diagram. The polygon is usually a triangle because the color gamut is usually defined by three color primaries, each represented by a vertex of this triangle.

FIG. 1 depicts a representation of an Original Color Gamut (OCG), and a representation of a Target Color Gamut (TCG) in the CIE 1931 xy chromaticity diagram (M. Pedzisz (2014). Beyond BT.709, SMPTE Motion Imaging Journal, vol. 123, no. 8, pp 18-25).

For example, the OCG corresponds to the BT.2020 color gamut, compatible with incoming UHDTV devices, while the TCG corresponds to the BT.709 color gamut compatible with existing HDTV devices. Such a TCG is usually named the Standard Color Gamut (SCG). As illustrated by FIG. 1, each color of a color gamut, here OCG, and thus each color image data representing a color of this color gamut, is represented by a 2D point M in this chromaticity diagram, and mapping a color of the OCG to a color of a different target color gamut TCG involves moving the 2D point M to a 2D point M′ representing a color of the TCG.

For example, mapping colors of the standard color gamut, typically BT.709, to the colors of a wider color gamut, typically BT. 2020, aims to provide, to the end-user, colors closer to real life, as the BT.2020 triangle comprises more natural colors than the BT.709 triangle.

Distributing OCG color image data, i.e. color image data representing a color of an OCG, involves the problem of backward compatibility with legacy devices which support only SCG color image data, i.e. color image data representing a color of a SCG. This is the so-called problem of color gamut incompatibility.

More precisely, distributing OCG color image data involves the co-existence in a same stream of an OCG, e.g. BT.2020, version of the color image data and a SCG, e.g. BT.709, version of those color image data.

This requires at some point a color gamut mapping from a first color gamut to a second color gamut should be performed without destroying the ability to restore the first color gamut version of the color image data from the second color gamut version of said color image data, i.e. in simple words, an invertible color gamut mapping.

The problem solved by the present principles is to provide a couple color gamut mapping/inverse gamut mapping that allows to shrink (mapping) a color gamut to a target (smaller) color gamut and then to expand back (inverse mapping) the target color gamut to the original color gamut. The goal is to allow the distribution of contents using workflows that use the target color gamut. By doing so, one also ensures backward compatibility between two workflows with two different gamuts.

A practical example is the compatibility between UHD using the wide BT.2020 gamut and HD using the smaller BT.709 gamut. The inverse gamut mapper allows to address both UHD and HD TV's, as shown on FIG. 2.

It is to be noted that the inverse mapping complexity should be low as it has to be implemented in a receiving device.

The (inverse) color gamut mapping may be combined with an inverse dynamic range reducer from HDR to SDR in order to provide backward compatibility from UHD/HDR to HD/SDR, as shown on FIG. 3. This an example of the foreseen DVB scenario that combines

legacy HD/SDR in BT.709

DVB/UHD phase 1, SDR in BT.2020

DVB/UHD phase 2, HDR in BT.2020

### 3. SUMMARY

The following presents a simplified summary of the disclosure in order to provide a basic understanding of some aspects of the disclosure. This summary is not an extensive overview of the disclosure. It is not intended to identify key or critical elements of the disclosure. The following summary merely presents some aspects of the disclosure in a simplified form as a prelude to the more detailed description provided below.

The disclosure sets out to remedy at least one of the drawbacks of the prior art with a method according to one of the following claims.

The present principles proposes an inverse gamut mapper that combines the following advantages

invertibility. Essential to recover the original full gamut content

low complexity of the inverse-color mapping. This ensures easy implementation on receiving devices.

invariance of colors near the white point. This preserves colors with memory (skin tone, etc.)

minimal derivative of the color mapping. The local expansion of colors is bounded in order to control at best the error of color coding that becomes more noticeable after gamut expansion.

According to one of its aspects, the present disclosure relates to a method for encoding color image data and a method for decoding color image data.

According to other of its aspects, the disclosure relates to a device comprising a processor configured to implement one of the above methods, a computer program product comprising program code instructions to execute the steps of one of the above method when this program is executed on a computer, and a non-transitory storage medium carrying instructions of program code for executing steps of one of the above method when said program is executed on a computing device.

The specific nature of the disclosure as well as other objects, advantages, features and uses of the disclosure will become evident from the following description of embodiments taken in conjunction with the accompanying drawings.

### 4. BRIEF DESCRIPTION OF DRAWINGS

In the drawings, an embodiment of the present disclosure is illustrated. It shows:

FIG. 1 depicts some example of color gamuts represented in the CIE 1931 xy chromaticity diagram;

FIG. 2 shows an example of a use case of a color gamut color mapping;

FIG. 3 shows an example of a use case of a color gamut color mapping combined with HDR/SDR process;

FIG. 4 shows a diagram of the steps of a method for processing color image data representing colors of an original color gamut in accordance with examples of the present principles;

FIG. 5 illustrates the inverse-color gamut mapping in accordance with examples of the present principles;

FIG. 6 illustrates the inverse-color gamut mapping in with examples of the present principles;

FIG. 7 shows a diagram of the steps of a method for processing color image data representing colors of an output color gamut in accordance with examples of the present principles;

FIG. 8 illustrates the color gamut mapping in accordance with an examples of the present principles;

FIG. 9 shows an example of an architecture of a device in accordance with an embodiment of the disclosure;

FIG. 10 shows two remote devices communicating over a communication network in accordance with an embodiment of the disclosure; and

Similar or same elements are referenced with the same reference numbers.

### 6. DESCRIPTION OF EMBODIMENTS

The present disclosure will be described more fully hereinafter with reference to the accompanying figures, in which embodiments of the disclosure are shown. This disclosure may, however, be embodied in many alternate forms and should not be construed as limited to the embodiments set forth herein. Accordingly, while the disclosure is susceptible to various modifications and alternative forms, specific embodiments thereof are shown by way of example in the drawings and will herein be described in detail. It should be understood, however, that there is no intent to limit the disclosure to the particular forms disclosed, but on the contrary, the disclosure is to cover all modifications, equivalents, and alternatives falling within the spirit and scope of the disclosure as defined by the claims.

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises”, “comprising,” “includes” and/or “including” when used in this specification, specify the presence of stated features, integers, steps, operations, elements, and/or components but do not preclude the presence or addition of one or more other features, integers, steps, operations, elements, components, and/or groups thereof. Moreover, when an element is referred to as being “responsive” or “connected” to another element, it can be directly responsive or connected to the other element, or intervening elements may be present. In contrast, when an element is referred to as being “directly responsive” or “directly connected” to other element, there are no intervening elements present. As used herein the term “and/or” includes any and all combinations of one or more of the associated listed items and may be abbreviated as“/”.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element without departing from the teachings of the disclosure.

Although some of the diagrams include arrows on communication paths to show a primary direction of communication, it is to be understood that communication may occur in the opposite direction to the depicted arrows.

Some embodiments are described with regard to block diagrams and operational flowcharts in which each block represents a circuit element, module, or portion of code which comprises one or more executable instructions for implementing the specified logical function(s). It should also be noted that in other implementations, the function(s) noted in the blocks may occur out of the order noted. For example, two blocks shown in succession may, in fact, be executed substantially concurrently or the blocks may sometimes be executed in the reverse order, depending on the functionality involved.

Reference herein to “one embodiment” or “an embodiment” means that a particular feature, structure, or characteristic described in connection with the embodiment can be included in at least one implementation of the disclosure. The appearances of the phrase “in one embodiment” or “according to an embodiment” in various places in the specification are not necessarily all referring to the same embodiment, nor are separate or alternative embodiments necessarily mutually exclusive of other embodiments.

Reference numerals appearing in the claims are by way of illustration only and shall have no limiting effect on the scope of the claims.

While not explicitly described, the present embodiments and variants may be employed in any combination or sub-combination.

The disclosure is described for mapping color image data. It extends to the color mapping of a picture because the color image data represents the pixels values, and it also extends to sequence of pictures (video) because each picture of the sequence is sequentially color mapped.

Moreover, the color image data are considered as expressed in a 3D xyY color space (or any other equivalent 3D color space). Consequently, when the color image data are expressed in another color space, for instance in an RGB color space, or in the CIE 1931 XYZ color space, or a differential coding color space such as YCbCr or YDzDx, conversion processes are applied to these color data.

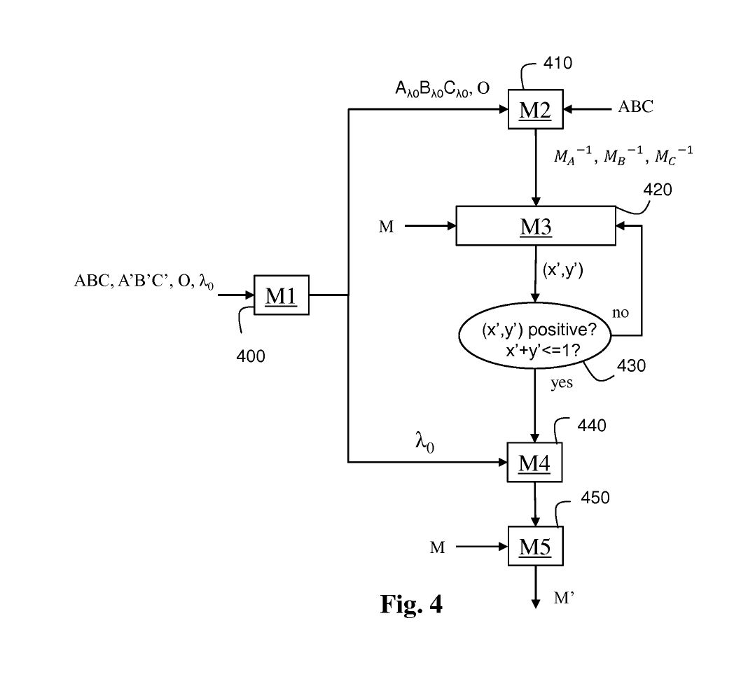

FIG. 4 shows a diagram of the steps of a method for processing color image data representing colors of an original color gamut in accordance with examples of the present principles.

The method for processing color image data comprises an inverse-color gamut mapping in the course of which color image data of an original color gamut is inverse-mapped to a mapped color image data of an output color gamut.

Usually, the original color gamut is smaller and included into the output color gamut. It is thus usual that the mapping described above is called “an inverse color gamut mapping” because it “expands” the surface of the gamut.

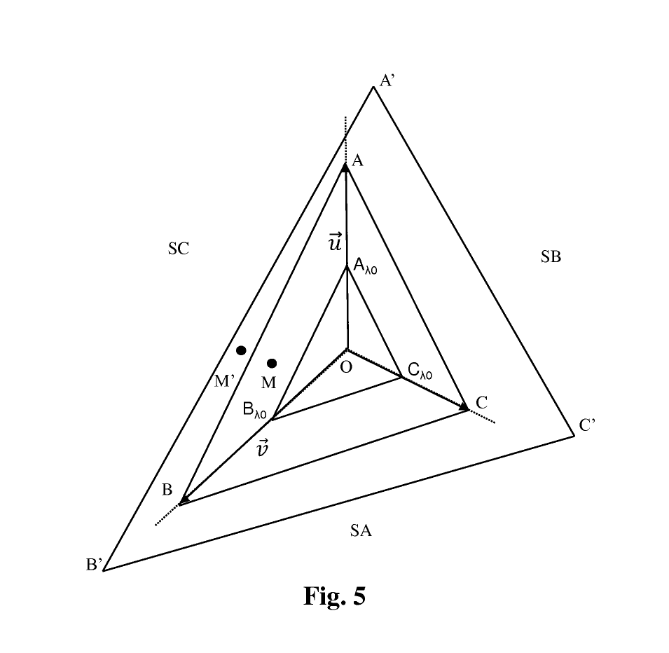

As illustrated in FIG. 5, let us consider an original color gamut that is represented as a triangle ABC in a chromaticity diagram relative to a suitable color space, like the CEI 1931 xy color coordinates. A white point O of said original color gamut, with coordinates (xw,yw), is also defined as point belonging to the triangle ABC. Let us define this white point O as the origin of a xy referential by subtracting the coordinates (xw,yw) of the white point O to the coordinates of any 2D point M representing color image data to be mapped. In the following the coordinates (x,y) of a 2D point M will be considered as being the coordinates of the 2D point M in said xy referential with origin O.

According to the present principles, the original color gamut (triangle ABC) is inverse-mapped onto the output color gamut represented by a triangle A′B′C′ in the xy referential under the condition that a preserved triangle A_{λ0}B_{λ0}C_{λ0}, located inside said triangle A′B′C′, is invariant under the inverse-mapping.

In other terms, any 2D point M belonging to the invariant triangle A_{λ0}B_{λ0}C_{λ0} remains unchanged under the inverse-mapping process. As a direct consequence of invertibility, it also remains unchanged under the mapping process, i.e. the reverse of the inverse-mapping process.

In step 400, a module M1 determines the triangle A_{λ0}_{λ0}C_{λ0} in the chromaticity diagram by applying an homothety to the triangle ABC, said homothety being centred on the white point O and using a scaling factor λ₀ belonging to the interval ]0,1[.

In step 410, a module M2 determines three angular sectors in the xy referential, each delimited by two lines starting from the center O of the triangle ABC and joining one of its vertices A, B or C, and computes a 2×2 matrix for each of those three angular sectors according to the triangle ABC.

According to an embodiment, illustrated in FIG. 5, a first angular sector SC is delimited by the half-lines [OA) and [OB), a second one SA is delimited by the half-lines [OB), [OC) and a third one SB is delimited by the half-lines [OA) and [OC). A matrix M_{C}⁻¹ is relative to the first angular sector SC, a matrix M_{A}⁻¹ is relative to the second angular SA sector and a matrix M_{B}⁻¹ is relative to the third angular sector SB.

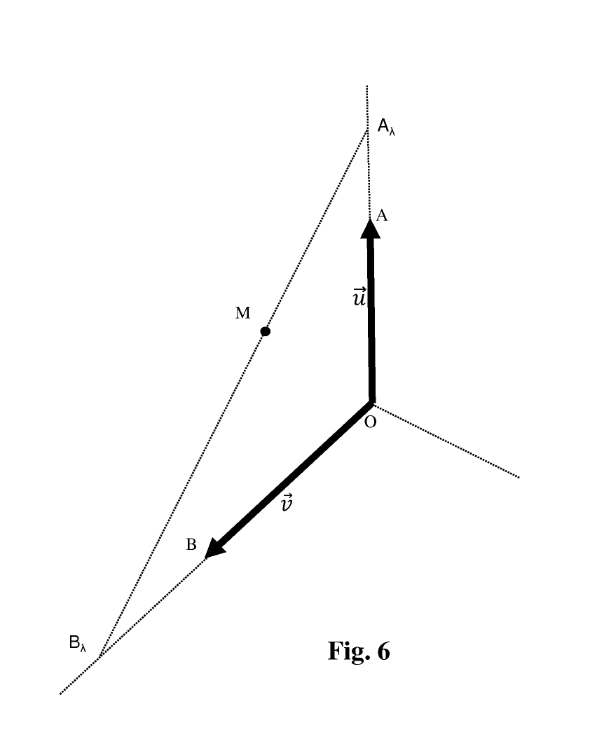

For example, as illustrated in FIG. 6, the matrix M_{C}⁻¹ is computed as follows:

Let \vec{u} and \vec{v} be the two vectors \vec{OA} and \vec{OB}, and let the two homothetic points A_{λ} and B_{λ} be defined by

\vec{OA_{λ}}=λ\vec{u} and \vec{OB_{λ}}=λ\vec{v}

for any real value λ. Then, there exists a unique real value λ such that a 2D point M belongs to the line (A_{λ}B_{λ}).

Using barycenter notations, this means that there exist two real numbers α, β (or weights) such that

α\vec{A_{λ}M}+β\vec{B_{λ}M}=0 with α+β=1

and then one gets

O=α\vec{A_{λ}O}+α\vec{OM}+β\vec{B_{λ}O}+β\vec{OM}=−αλ\vec{u}−βλ\vec{v}+\vec{OM}

and in matrix notation, this leads to:

$$[ \begin{matrix}x \\ y\end{matrix} ] = {M}_{C} [ \begin{matrix}αλ \\ βλ\end{matrix} ]$$

where M_{C} is the 2×2 matrix [\vec{u}, \vec{v})] that depends only on the triangle ABC, the white point O, but not the coordinates (x,y) of the 2D point M.

The matrix M_{C}⁻¹ is the inverse of the matrix M_{C}.

In a similar way, the matrix M_{B}⁻¹ is computed when the two vectors \vec{OA}and \vec{OB} are replaced by the two vectors \vec{OA} and \vec{OC} respectively, and the matrix M_{A}⁻¹ is computed when the two vectors \vec{OA} and \vec{OB} are replaced by the two vectors \vec{OB} and \vec{OC} respectively.

The steps 400 and 410 may be computed once, preferably beforehand because they do not depend on the coordinates of the 2D point M to be mapped.

In step 420, a module M3 computes intermediate coordinates (x′,y′) of a 2D point M to be mapped assuming this 2D point M belongs to one of the three angular sectors SA, SB or SC by multiplying the coordinates (x,y) of the 2D point M by the matrix relative to said angular sector.

For example, when the first angular sector is considered, intermediate coordinates (x′,y′) are computed by:

$${M}_{C}^{- 1} [ \begin{matrix}x \\ y\end{matrix} ] = \text{:} [ \begin{matrix}{x}^{′} \\ {y}^{′}\end{matrix} ] .$$

Next, the sum λ of these intermediate coordinates are also computed by:

x′+y′=αλ+βλ=(α+β)λ=λ.

Then a module checks if those intermediate coordinates (x′, y′) are positive values and if their sum λ is lower than or equal to 1:

M ∈ (OAB)⇔x′,y′≥0 and x′+y′=λ≤1.

In step 430, if those intermediate coordinates (x′, y′) are positive values and if their sum λ is lower or equal to 1, then the 2D point M belongs to the current angular sector and the step 430 is followed by a step 440. Otherwise the module M3 computes other intermediate coordinates (x′,y′) by considering another angular sector (step 420).

In step 440, a module M4 determines if the 2D point M belongs to the triangle A_{λ0}B_{λ0}C_{λ0}.

According to an embodiment of the step 440, the 2D point M belongs to the triangle A_{λ0}B_{λ0}C_{λ0} if and only if the sum λ of the intermediate coordinates (x′,y′) of the 2D point M is lower than or equal to λ₀o. Otherwise (λ₀<λ), the 2D point M is not invariant, i.e. does not belong to the triangle A_{λ0}B_{λ0}C_{λ0}.

The 2D point M, thus, graphically belongs to one of three quadrilaterals defined by the vertices of the triangles ABC and A_{λ0}B_{λ0}C_{λ0} (namely A_{λ0}B_{λ0}BA, A_{λ0}C_{λ0}CA and C_{λ0}BA_{λ0}BC as shown in FIG. 5).

If the 2D point M is not invariant, the 2D point M′ belongs to a quadrilateral defines from two vertices of the triangle A′B′C′ and two vertices of the triangle A_{λ0}B_{λ0}C_{λ0} , and, in step 450, a module M5 determines the coordinates of the 2D point M′ as being a weighted linear combination of the coordinates of those four vertices. One of the weights depending on the distance of the 2D point M to a line joining two vertices of the triangle A_{λ0}B_{λ0}C_{λ0} relatively to a line joining the two vertices of the triangle ABC.

For example, assuming that the 2D point M belongs to the angular sector SC and is no invariant. Then, the 2D point M belongs to the quadrilateral A_{λ0}B_{λ0}BA and the 2D point M′ (mapped 2D point M) belongs to the quadrilateral A_{λ0}B_{λ0}B′A′.

Let us define a normalized distance μ of the 2D point M to the line (A_{λ0}B_{λ0}) relatively to the line (AB) as

μ=(λ−λ₀)/(1−λ₀)

which belongs to the interval ]0,1]. This basically provides a parameter of expansion from (A_{λ0}B_{λ0}) to (A′B′) for the mapping.

Two weights α, β are then defined by:

α=x′/λ and β=y′/λ.

Let us also define A_{μ} as the expansion from A_{λ0} to A′ by the factor μ as follows

(1−μ) \vec{A_{λ0}A_{μ}}+μ\vec{A′A_{μ}}=O

and B_{μ} as the expansion from B_{λ0} to B′ by the factor μ as follows

(1−μ) \vec{B_{λ0}B_{μ}}+μ\vec{B′B_{μ}}=O.

The 2D point M′ (mapped 2D point M) is defined as the same barycenter between A_{μ} and B_{μ} as M is between A_{λ} and B_{λ}. This leads to

α\vec{A_{μ}M′}+β\vec{B_{μ}M′}=0

Practically, the 2D point M′ is found by the vector relation

\vec{OM′}=α\vec{OA_{μ}}+β\vec{OB_{μ}}=α((1−μ)\vec{OA_{λ0}}+μ\vec{OA′}) +β(1−μ) \vec{OB_{λ0}}+μ\vec{OB′})

and the coordinates of the 2D point M′ are then given by the following weighted linear combination of the coordinates of the vertices A_{λ0}, B_{λ0}, B′ and A′:

M′=α(1−μ)A_{λ0}+αμA′+β(1−μ)B_{μ0}+βμB′

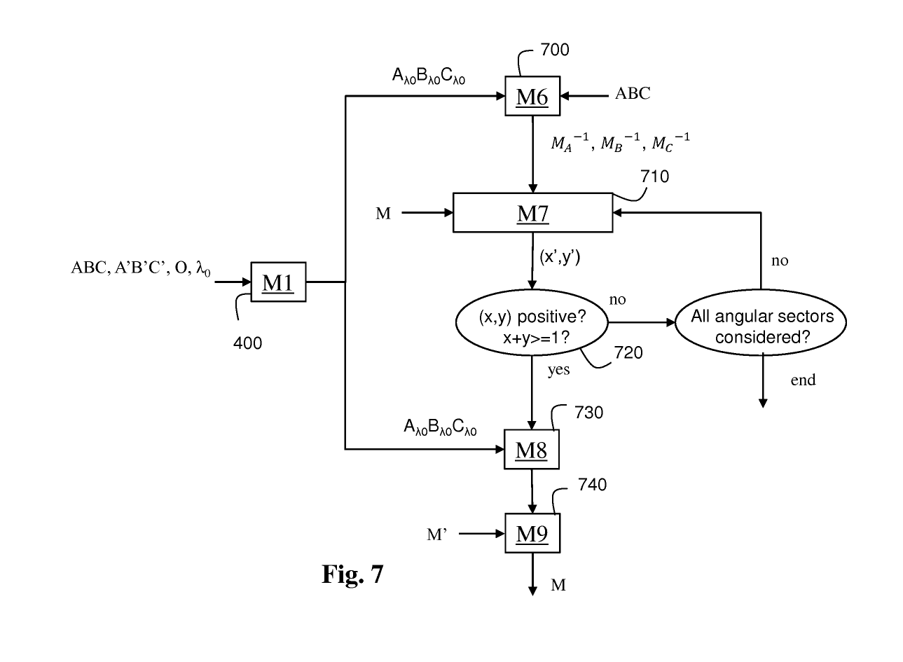

FIG. 7 shows a diagram of the steps of a method for processing color image data representing colors of an output color gamut in accordance with examples of the present principles.

The method for processing color image data comprises a color gamut mapping in the course of which mapped color image data of an output color gamut, represented by a 2D point M′ in the triangle A′B′C′, is mapped to a color image data of an original color gamut, represented by a 2D point M in the triangle ABC.

The color gamut mapping of FIG. 7 is the reverse process of the inverse-color gamut mapping described in relation with FIG. 4.

In step 400, a module M1 determines the triangle A_{λ0}B_{λ0}C_{λ0} in the chromaticity diagram as described in relation with FIG. 4.

In step 700, a module M6 determines three angular sectors SA, SB and SC, each angular sector being delimited by a first half-line defined by an intersection point S and a vertex of the triangle A′B′C′ and a second half-line defined by another vertex of the triangle A′B′C′ and said intersection point S. Said intersection point S is defined by the intersection of a first half-line defined by a vertex of the triangle A′B′C′ and a vertex of the triangle A_{λ0}B_{λ0}C_{λ0} and a second half-line defined by another vertex of the triangle A_{λ0}B_{λ0}C_{λ0} and another vertex of the triangle A′B′C′. In step 700, and a module further computes a matrix for each of those three angular sectors SA, SB and SC according to the triangle A′B′C′.

A matrix M_{C}⁻¹ is relative to the first angular sector SC, a matrix M_{A}⁻¹ is relative to the second angular SA sector and a matrix M_{B}⁻¹ is relative to the third angular sector SB.

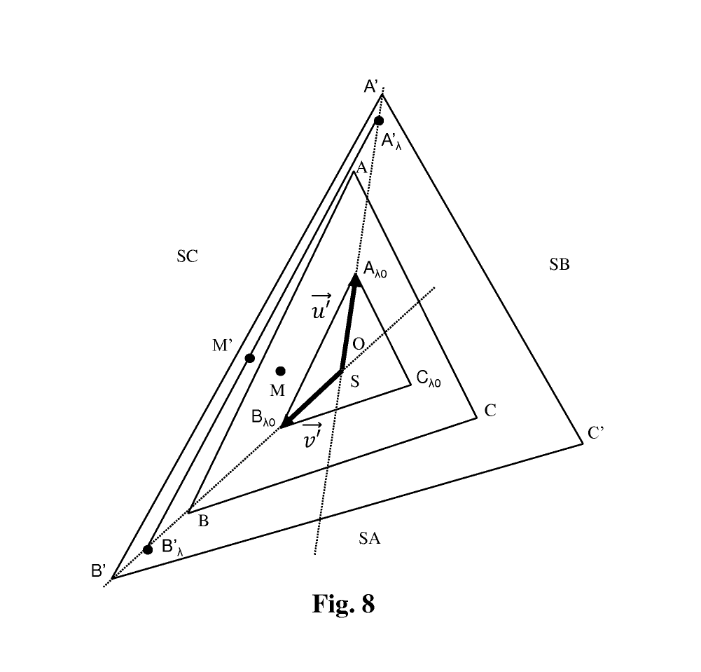

According to an embodiment, illustrated in FIG. 8, a first angular sector SC is delimited by the half-lines [SA′) and [SB′). The intersection point S is defined as the intersection between a half-line defined by the vertices A′ and A_{λ0} and a half-line defined by the vertices B′ and B_{λ0}.

A second angular sector SA may also be delimited by half-lines [S1B), [S1C) (not shown in FIG. 8). A second intersection point S1 is defined as the intersection between a half-line defined by the vertices B′ and B_{λ0} and a half-line defined by the vertices C′ and C_{λ0}.

A third angular sector SB may further be delimited by half-lines [S2A) and [S2) (not shown in FIG. 8). A third intersection point S2 is defined as the intersection between a half-line defined by the vertices A′ and A_{λ0} and a half-line defined by the vertices C′ and C_{λ0}.

For example, as illustrated in FIG. 8, the matrix M_{C}⁻¹ is computed as follows:

Let \vec{u′} and \vec{v′} be the two vectors \vec{SA_{λ0}} and \vec{SB_{λ0},} , and let two homothetic points A_{μ} and B_{μ′} defined by

\vec{SA_{μ′}}=μ′\vec{u′} and \vec{SB_{μ′}}=μ′\vec{v′}

for any real value μ′. Then, there exists a unique real value λ such that a 2D point M′ belongs to the line (A_{μ′}B_{μ′}).

Using barycenter notations, this means that there exists two real numbers α, β (or weights) such that

α\vec{A_{μ},M′}+β\vec{B_{μ}, M′}=0 with α+β=1

and then one gets

0=α\vec{A_{μ},O}+α\vec{SM′}+βB_{μ}\vec{S}+β\vec{SM′}=−αμ′\vec{u′}−βμ′\vec{v′}+\vec{SM′}

and in matrix notation, this leads to:

$$[ \begin{matrix}{x}^{′} - {S}_{x} \\ {y}^{′} - {S}_{y}\end{matrix} ] = {M}_{C} [ \begin{matrix}{αμ}^{′} \\ {βμ}^{′}\end{matrix} ]$$

where M_{C} is the 2×2 matrix [\vec{u′},\vec{v′}] that depends only on the triangle A′B′C′, the intersection point S, but not the coordinates (x′,y′) of the 2D point M′. The coordinates of the intersection point S are noted Sₓ and S_{y}. As a consequence,

$$[ \begin{matrix}{x}^{′} - {S}_{x} \\ {y}^{′} - {S}_{y}\end{matrix} ]$$

are the coordinates of the 2D point M′ in a xy referential centred on the intersection point S (or S1 or S2 according to the angular sector).

The matrix M_{C}⁻¹ is the inverse of the matrix M_{C}.

In a similar way, the matrix M_{B}⁻¹ is computed when the two vectors \vec{SA_{λ0}} and \vec{SB_{λ0}} are replaced by the two vectors \vec{S₁A_{λ0}} and \vec{S₁C_{λ0}} respectively, and the matrix M_{A}⁻¹ is computed when the two vectors \vec{SA_{λ0}} and \vec{SB_{Aλ0}} are replaced by the two vectors \vec{S₂B_{λ0}} and \vec{S₂C_{λ0}} respectively.

The steps 400 and 700 may be computed once, preferably beforehand because they do not depend on the coordinates of the 2D point M′.

In step 710, the module M7 computes intermediate coordinates (x,y) of a 2D point M′ assuming this 2D point M′ belongs to one of the three angular sectors SA, SB or SC by multiplying the coordinates of the 2D point M′, relatively to the intersection point S (or S1 or S2 according to the angular sector) of said angular sector, by the matrix relative to said angular sector.

For example, when the first angular sector is considered, intermediate coordinates (x,y) are computed by:

$$[ \begin{matrix}x \\ y\end{matrix} ] := {M}_{C}^{′ - 1} [ \begin{matrix}{x}^{′} - {S}_{x} \\ {y}^{′} - {S}_{y}\end{matrix} ] .$$

Next, the sum μ′ of these intermediate coordinates are also computed by:

μ′=x+y.

Then a module checks (step 720) if those intermediate coordinates (x, y) are positive values and if their sum μ′ is greater than 1:

M′ ∈ (SA′B′) and M′ not invariant⇔x, y≥0 and x+y=μ′>1.

The first condition x,y≥0 ensures that the 2D point M′ belongs to the angular sector. The second condition x+y=μ′>1 ensures that the 2D point M′ does not belong to the invariant triangle A_{λ0}B_{λ0}C_{λ0}.

In step 720, if those intermediate coordinates (x, y) are positive values and if their sum μ′ is greater than 1, then the 2D point M′ belongs to the current angular sector and is not invariant. In this case, the step 720 is followed by a step 730. Otherwise the module M7 computes other intermediate coordinates (x,y) by considering another angular sector (step 710). If the module M7 has considered all angular sectors and none of the associated coordinates (x, y) fulfill the two conditions, the 2D point M′ is invariant and belongs to the triangle A_{λ0}B_{λ0}C_{λ0}.

In step 730, (the 2D point M′ is not invariant), the reversed mapped 2D point M belongs to a quadrilateral defined from two vertices of the triangle ABC and two vertices of the triangle A_{λ0}B_{λ0}C_{λ0}(namely A_{λ0}B_{λ0}BA, A_{λ0}C_{λ0}CA and C_{λ0}B_{λ0}BC as shown in FIG. 8), and, in step 740, a module M9 determines the coordinates of the 2D point M as being a weighted linear combination of the coordinates of those four vertices.

For example, assuming that the 2D point M′ belongs to the angular sector SC and is not invariant, then the 2D point M′ belongs to the quadrilateral A_{λ0}B_{λ0}B′A′ and the reversed mapped 2D point M belongs to the quadrilateral A_{λ0}B_{λ0}BA. Then it is possible to determine back the normalized distance μ used in the inverse-mapping process. By definition of μ, one has

M′ ∈ (A_{μ}B_{μ}).

As a consequence, there exists a parameter η such that

\vec{A_{μ}M′}=η\vec{A_{μ}B_{μ}}.

Now working with vertices coordinates, one gets

M′−A_{μ}=η(B_{μ}−A_{μ})

⇒M′−(1−μ)A_{λ0}−μA′=η(1−μ)(B_{λ0}−A_{λ0})+μ(B′−A′))

⇒M′−A_{λ0}+μ(A_{λ0}−A′)=η(B_{λ0}−A_{λ0}+μ(B′−A′−B_{λ0}+A_{λ0}))

and one rewrites this in term of vectors

\vec{c₁}+μ\vec{c₂}=η(\vec{c₃}+μ\vec{c₄}).

Then by cancelling η by using the two relations on x and y, one finds

(c₁^{x}+μ c₂^{x})(c₃^{y}+μc₄^{y})=(c₁^{y}+μc₂^{y})(c₃^{x}+μc₄^{x}).

This is a second order polynomial in μ whose solutions are easily solved by using the discriminant formula. The choice of the solution, i.e. the sign behind the discriminant, is found by geometrical argument and this sign is fixed for all points of the quadrilateral.

Once the normalized distance μ is determined back, it is easy to invert the formula μ=(λ−λ₀)/(1−λ₀) to determine the parameter λ back. Finally, the two parameters α and β are found by the following ratio (x′−A_{μx})/(B_{μx}−A_{μx}) and the relation α=1−β. By definiton, the 2D point M is the (α, β)-barycenter of A_{λ} and B_{λ}. Since A_{λ} (resp. B_{λ}) is a barycenter of A_{λ0} and A (resp. B_{λ0} and B), then the 2D point M is a weighted linear combination of the coordinates of those four vertices A_{λ0}, A, B_{λ0} and B as stated above.

As mentioned before, one of the advantages of the disclosure is to provide a color gamut mapping that can be invertible and as far as possible of limited complexity to be implementable on hardware or FPGA platforms used for instance in Set-top-boxes or blu-ray players for example. In addition it has to preserve as much as possible the color in the Target Color Gamut (TGC).

According to an embodiment of the disclosure, the CIE 1931 xyY chromaticity diagram is used. However, the disclosure extends to any other chromaticity diagram such as CIE Luv (2D coordinate systems define by u and v components), or CIE Lab (2D coordinate systems define by a and b components).

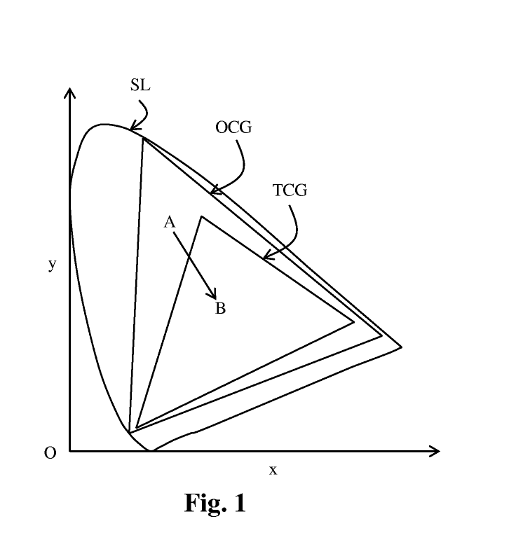

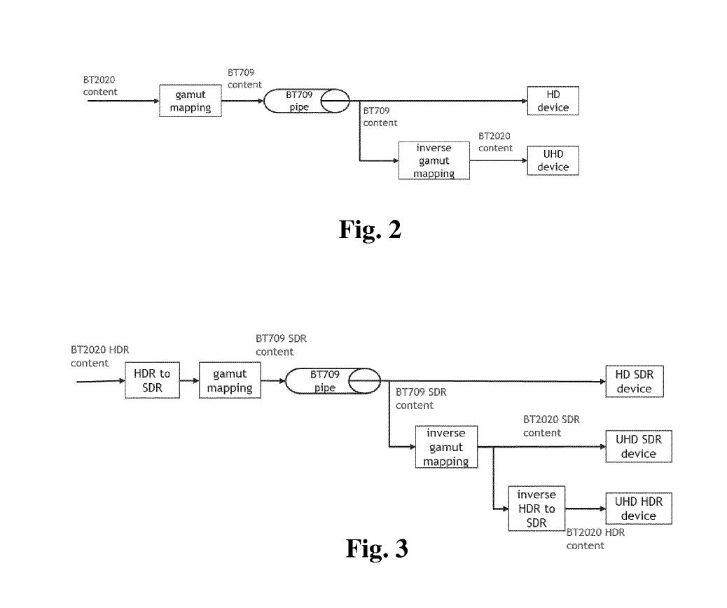

On FIG. 1-8, the modules are functional units, which may or not be in relation with distinguishable physical units. For example, these modules or some of them may be brought together in a unique component or circuit, or contribute to functionalities of a software. A contrario, some modules may potentially be composed of separate physical entities. The apparatus which are compatible with the disclosure are implemented using either pure hardware, for example using dedicated hardware such ASIC or FPGA or VLSI, respectively «Application Specific Integrated Circuit», «Field-Programmable Gate Array», «Very Large Scale Integration», or from several integrated electronic components embedded in a device or from a blend of hardware and software components.

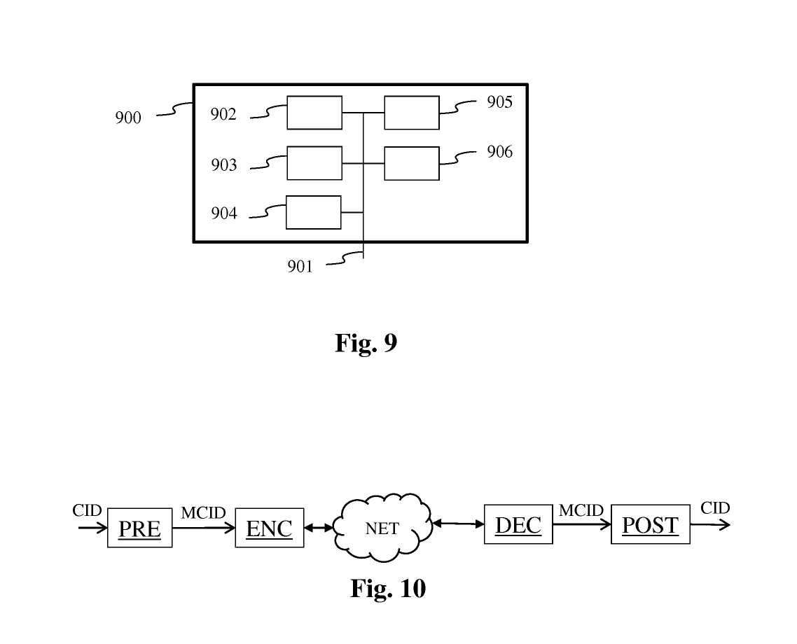

FIG. 9 represents an exemplary architecture of a device 900 which may be configured to implement a method described in relation with FIG. 1-8.

Device 900 comprises following elements that are linked together by a data and address bus 901:
a microprocessor 902 (or CPU), which is, for example, a DSP (or Digital Signal Processor);
a ROM (or Read Only Memory) 903;
a RAM (or Random Access Memory) 904;
an I/O interface 905 for reception of data to transmit, from an application; and
a battery 906.

According to a variant, the battery 906 is external to the device. Each of these elements of FIG. 9 is well-known by those skilled in the art and won't be disclosed further. In each of mentioned memory, the word «register» used in the specification can correspond to area of small capacity (some bits) or to very large area (e.g. a whole program or large amount of received or decoded data). ROM 903 comprises at least a program and parameters. Algorithm of the methods according to the disclosure is stored in the ROM 903. When switched on, the CPU 902 uploads the program in the RAM and executes the corresponding instructions.

RAM 904 comprises, in a register, the program executed by the CPU 902 and uploaded after switch on of the device 900, input data in a register, intermediate data in different states of the method in a register, and other variables used for the execution of the method in a register.

The implementations described herein may be implemented in, for example, a method or a process, an apparatus, a software program, a data stream, or a signal. Even if only discussed in the context of a single form of implementation (for example, discussed only as a method or a device), the implementation of features discussed may also be implemented in other forms (for example a program). An apparatus may be implemented in, for example, appropriate hardware, software, and firmware. The methods may be implemented in, for example, an apparatus such as, for example, a processor, which refers to processing devices in general, including, for example, a computer, a microprocessor, an integrated circuit, or a programmable logic device. Processors also include communication devices, such as, for example, computers, cell phones, portable/personal digital assistants (“PDAs”), and other devices that facilitate communication of information between end-users.

FIG. 10 shows schematically an encoding/decoding scheme in a transmission context between two remote devices A and B over a communication network NET, the device A comprises a processor in relation with memory RAM and ROM which are configured to implement a method for encoding a picture (or a sequence of picture) into a stream F and the device B comprises a processor in relation with memory RAM and ROM which are configured to implement a method for decoding a picture from a stream F.

The encoding method comprises a pre-processing module PRE configured to implement an inverse-color gamut mapping of the color image data obtained from the picture (or each picture of a sequence of picture) to be encoded. The pre-processed color image data are then encoded by the encoder ENC. Said pre-processing may conform to the method described in relation with FIG. 4, and may be used to adapt an original color gamut, e.g. a wide color gamut, e.g. BT. 2020, to a target color gamut, typically a standard color gamut such as BT. 709.

The decoding method comprises a module POST configured to implement an inverse color gamut mapping of decoded color image data obtained from a decoder DEC. Said post-processing method may conform to the method described in relation with FIG. 7, may be used to adapt the color gamut of the decoded picture to a target color gamut, typically a wide color gamut such as BT. 2020 or any other output color gamut adapted, for example to a display.

According to a variant of the disclosure, the network is a broadcast network, adapted to broadcast still pictures or video pictures from device A to decoding devices including the device B.

According to a specific embodiment, color image data at the encoding side and decoded color image data at the decoding side, are obtained from a source. For example, the source belongs to a set comprising:
a local memory (903 or ç04), e.g. a video memory or a RAM (or Random Access Memory), a flash memory, a ROM (or Read Only Memory), a hard disk ;
a storage interface (905), e.g. an interface with a mass storage, a RAM, a flash memory, a ROM, an optical disc or a magnetic support;
a communication interface (905), e.g. a wireline interface (for example a bus interface, a wide area network interface, a local area network interface) or a wireless interface (such as a IEEE 802.11 interface or a Bluetooth® interface); and
a picture capturing circuit (e.g. a sensor such as, for example, a CCD (or Charge-Coupled Device) or CMOS (or Complementary Metal-Oxide-Semiconductor)).

According to different embodiments, pre-processed or post-processed color image data are sent to a destination; specifically, the destination belongs to a set comprising:
a local memory (903 or 904), e.g. a video memory or a RAM, a flash memory, a hard disk ;
a storage interface (905), e.g. an interface with a mass storage, a RAM, a flash memory, a ROM, an optical disc or a magnetic support;
a communication interface (905), e.g. a wireline interface (for example a bus interface (e.g. USB (or Universal Serial Bus)), a wide area network interface, a local area network interface, a HDMI (High Definition Multimedia Interface) interface) or a wireless interface (such as a IEEE 802.11 interface, WiFi ® or a Bluetooth ® interface); and
a display.

According to different embodiments of encoding or encoder, the stream F is sent to a destination. As an example, one of stream F is stored in a local or remote memory, e.g. a video memory (904) or a RAM (904), a hard disk (903). In a variant, the stream F is sent to a storage interface (905), e.g. an interface with a mass storage, a flash memory, ROM, an optical disc or a magnetic support and/or transmitted over a communication interface (905), e.g. an interface to a point to point link, a communication bus, a point to multipoint link or a broadcast network.

According to different embodiments of decoding or decoder, the stream F is obtained from a source. Exemplarily, the stream F is read from a local memory, e.g. a video memory (904), a RAM (904), a ROM (903), a flash memory (903) or a hard disk (903). In a variant, the bitstream is received from a storage interface (905), e.g. an interface with a mass storage, a RAM, a ROM, a flash memory, an optical disc or a magnetic support and/or received from a communication interface (905), e.g. an interface to a point to point link, a bus, a point to multipoint link or a broadcast network.

According to different embodiments, device 900, being configured to implement an encoding method as described above, belongs to a set comprising:
a mobile device ;
a communication device ;
a game device ;
a tablet (or tablet computer) ;
a laptop ;
a still picture camera;
a video camera ;
an encoding chip;
a still picture server ; and
a video server (e.g. a broadcast server, a video-on-demand server or a web server).

According to different embodiments, device 900, being configured to implement a decoding method as described above, belongs to a set comprising:
a mobile device ;
a communication device ;
a game device ;
a set top box;
a TV set;
a tablet (or tablet computer) ;
a laptop ;
a display and
a decoding chip.

Implementations of the various processes and features described herein may be embodied in a variety of different equipment or applications. Examples of such equipment include an encoder, a decoder, a post-processor processing output from a decoder, a pre-processor providing input to an encoder, a video coder, a video decoder, a video codec, a web server, a set-top box, a laptop, a personal computer, a cell phone, a PDA, and any other device for processing a picture or a video or other communication devices. As should be clear, the equipment may be mobile and even installed in a mobile vehicle.

Additionally, the methods may be implemented by instructions being performed by a processor, and such instructions (and/or data values produced by an implementation) may be stored on a computer readable storage medium. A computer readable storage medium can take the form of a computer readable program product embodied in one or more computer readable medium(s) and having computer readable program code embodied thereon that is executable by a computer. A computer readable storage medium as used herein is considered a non-transitory storage medium given the inherent capability to store the information therein as well as the inherent capability to provide retrieval of the information therefrom. A computer readable storage medium can be, for example, but is not limited to, an electronic, magnetic, optical, electromagnetic, infrared, or semiconductor system, apparatus, or device, or any suitable combination of the foregoing. It is to be appreciated that the following, while providing more specific examples of computer readable storage mediums to which the present principles can be applied, is merely an illustrative and not exhaustive listing as is readily appreciated by one of ordinary skill in the art: a portable computer diskette; a hard disk; a read-only memory (ROM); an erasable programmable read-only memory (EPROM or Flash memory); a portable compact disc read-only memory (CD-ROM); an optical storage device; a magnetic storage device; or any suitable combination of the foregoing.

The instructions may form an application program tangibly embodied on a processor-readable medium.

Instructions may be, for example, in hardware, firmware, software, or a combination. Instructions may be found in, for example, an operating system, a separate application, or a combination of the two. A processor may be characterized, therefore, as, for example, both a device configured to carry out a process and a device that includes a processor-readable medium (such as a storage device) having instructions for carrying out a process. Further, a processor-readable medium may store, in addition to or in lieu of instructions, data values produced by an implementation.

As will be evident to one of skill in the art, implementations may produce a variety of signals formatted to carry information that may be, for example, stored or transmitted. The information may include, for example, instructions for performing a method, or data produced by one of the described implementations. For example, a signal may be formatted to carry as data the rules for writing or reading the syntax of a described embodiment, or to carry as data the actual syntax-values written by a described embodiment. Such a signal may be formatted, for example, as an electromagnetic wave (for example, using a radio frequency portion of spectrum) or as a baseband signal. The formatting may include, for example, encoding a data stream and modulating a carrier with the encoded data stream. The information that the signal carries may be, for example, analog or digital information. The signal may be transmitted over a variety of different wired or wireless links, as is known. The signal may be stored on a processor-readable medium.

A number of implementations have been described. Nevertheless, it will be understood that various modifications may be made. For example, elements of different implementations may be combined, supplemented, modified, or removed to produce other implementations. Additionally, one of ordinary skill will understand that other structures and processes may be substituted for those disclosed and the resulting implementations will perform at least substantially the same function(s), in at least substantially the same way(s), to achieve at least substantially the same result(s) as the implementations disclosed. Accordingly, these and other implementations are contemplated by this application.

1. A method for processing color image data representing colors of an original color gamut, wherein the method comprises an inverse-color gamut mapping step in the course of which color image data, represented by a 2D point M belonging to a triangle ABC, is mapped to a mapped color image data of an output color gamut, said triangle ABC representing the original color gamut in a chromaticity diagram and centered on the white point O of the original color gamut, said mapped color image data of the output color gamut being represented by a 2D point M′ belonging to a triangle A′B′C′ representing the output color gamut in the chromaticity diagram, wherein the inverse-color gamut mapping step comprises sub-steps of:
determining a triangle A_{λ0}B_{λ0}C_{λ0} in the chromaticity diagram by applying an homothety to the triangle ABC, said homothety being centered on the white point O and using a scaling factor λ₀, said triangle A_{λ0}B_{λ0}C_{λ0} representing a preserved color gamut in which the color image data remain unchanged;
determining three angular sectors in the chromaticity diagram, each delimited by two lines starting from the white point O and joining one of the vertices A, B or C of the triangle ABC, and computing a 2×2 matrix for each of those three angular sectors according to the triangle ABC;
computing intermediate coordinates of the 2D point M, assuming this 2D point M belongs to one of the three angular sectors, by multiplying the coordinates of the 2D point M by the matrix relative to said angular sector;
if those intermediate coordinates are positive values and if their sum is lower or equal to 1, then the 2D point M belongs to the current angular sector, otherwise other intermediate coordinates are computed by considering another angular sector;
if the 2D point M does not belong to the triangle A_{λ0}B_{λ0}C_{λ0}, the 2D point M belonging to a quadrilateral defined by two vertices of the triangle A_{λ0}B_{λ0}C_{λ0} and two vertices of the triangle A′B′C′, determining the coordinates of the 2D point M′ as being a weighted linear combination of the coordinates of said four vertices, one of the weights of said combination depending on the distance of the 2D point M to a line joining two vertices of the triangle A_{λ0}B_{λ0}C_{λ0} relatively to a line joining the two vertices of the triangle ABC.

2. A method for processing color image data representing colors of an output color gamut, wherein the method comprises a color gamut mapping step in the course of which mapped color image data, represented by a 2D point M′ belonging to a triangle A′B′C′, is mapped to a color image data of an original color gamut, said triangle A′B′C′ representing the output color gamut in a chromaticity diagram, said color image data of the original color gamut being represented by a 2D point M belonging to a triangle ABC representing the original color gamut in the chromaticity diagram, wherein the color gamut mapping step comprises sub-steps of:
determining a triangle A_{λ0}B_{λ0}C_{λ0} in the chromaticity diagram by applying an homothety to the triangle ABC, said homothety being centered on the white point of the original color gamut mapping and using a scaling factor λ₀, said triangle A_{λ0}B_{λ0}C_{λ0} representing a preserved color gamut in which the color image data remain unchanged;
determining three angular sectors in the chromaticity diagram, a first, respectively second and third, angular sector being delimited by a first half-line defined by an intersection point S, respectively S1 and S2, and a vertex of the triangle A′B′C′ and a second half-line defined by another vertex of the triangle A′B′C′ and said intersection point S, respectively S1 and S2, said intersection point S, respectively S1 and S2, being defined as the intersection of a first half-line defined by a vertex of the triangle A′B′C′ and a vertex of the triangle A_{λ0}B_{λ}C_{λ0}, and a second half-line defined by another vertex of the triangle A_{λ0}B_{λ0}C_{λ0} and another vertex of the triangle A′B′C′, and computing a 2×2 matrix for each of those three angular sectors SA, SB and SC according to the triangle A′B′C′;
computing intermediate coordinates of the 2D point M′, assuming this 2D point M′ belongs to one of the three angular sectors, by multiplying the coordinates of the 2D point M′, relatively to the intersection point S, S1 or S2 according to the angular sector by the matrix relative to said angular sector;
if those intermediate coordinates are positive values and if their sum is greater than or equal to 1, then the 2D point M′ belongs to a current angular sector and is not invariant, the 2D point M belongs to a quadrilateral defined from two vertices of the triangle ABC and two vertices of the triangle A_{λ0}B_{λ0}C_{λ0}, and the coordinates of the 2D point M are determined as being a weighted linear combination of the coordinates of those four vertices,
otherwise other intermediate coordinates are computed by considering another angular sector.

3. A method for encoding color image data, wherein the method comprises an inverse-color gamut mapping step in the course of which color image data, represented by a 2D point M belonging to a triangle ABC, is mapped to a mapped color image data of an output color gamut, said triangle ABC representing the original color gamut in a chromaticity diagram and centered on the white point O of the original color gamut, said mapped color image data of the output color gamut being represented by a 2D point M′ belonging to a triangle A′B′C′ representing the output color gamut in the chromaticity diagram, wherein the inverse-color gamut mapping comprises sub-steps of:
determining a triangle A_{λ0}B_{λ0}C_{λ0} in the chromaticity diagram by applying an homothety to the triangle ABC, said homothety being centered on the white point O and using a scaling factor λ₀, said triangle A_{λ0}B_{λ0}C_{λ0} representing a preserved color gamut in which the color image data remain unchanged;
determining three angular sectors in the chromaticity diagram, each delimited by two lines starting from the white point O and joining one of the vertices A, B or C of the triangle ABC, and computing a 2×2 matrix for each of those three angular sectors according to the triangle ABC;
computing intermediate coordinates of the 2D point M, assuming this 2D point M belongs to one of the three angular sectors, by multiplying the coordinates of the 2D point M by the matrix relative to said angular sector;
if those intermediate coordinates are positive values and if their sum is lower or equal to 1, then the 2D point M belongs to the current angular sector, otherwise other intermediate coordinates are computed by considering another angular sector;
if the 2D point M does not belong to the triangle A_{λ0}B_{λ0}C_{λ0}, the 2D point M belonging to a quadrilateral defined by two vertices of the triangle A_{λ0}B_{λ0}C_{λ0} and two vertices of the triangle A′B′C′, determining the coordinates of the 2D point M′ as being a weighted linear combination of the coordinates of said four vertices, one of the weights of said combination depending on the distance of the 2D point M to a line joining two vertices of the triangle A_{λ0}B_{λ0}C_{λ0} relatively to a line joining the two vertices of the triangle ABC.

4. A method for decoding color image data, wherein the method comprises a color gamut mapping step in the course of which decoded color image data, represented by a 2D point M′ belonging to a triangle A′B′C′, is mapped to a color image data of an original color gamut, said triangle A′B′C′ representing the output color gamut in a chromaticity diagram, said color image data of the original color gamut being represented by a 2D point M belonging to a triangle ABC representing the original color gamut in the chromaticity diagram, wherein the color gamut mapping step comprises sub-steps of:
determining a triangle A_{λ0}B_{λ0}C_{λ0} in the chromaticity diagram by applying an homothety to the triangle ABC, said homothety being centered on the white point of the original color gamut mapping and using a scaling factor λ, said triangle A_{λ0}B_{λ0}C_{λ0} representing a preserved color gamut in which the color image data remain unchanged;
determining three angular sectors in the chromaticity diagram, a first, respectively second and third, angular sector being delimited by a first half-line defined by an intersection point S, respectively S1 and S2, and a vertex of the triangle A′B′C′ and a second half-line defined by another vertex of the triangle A′B′C′ and said intersection point S, respectively S1 and S2, said intersection point S, respectively S1 and S2, being defined as the intersection of a first half-line defined by a vertex of the triangle A′B′C′ and a vertex of the triangle A_{λ0}B_{λ0}C_{λ0} and a second half-line defined by another vertex of the triangle A_{λ0}B_{λ0}C_{λ0} and another vertex of the triangle A′B′C′, and computing a 2×2 matrix for each of those three angular sectors SA, SB and SC according to the triangle A′B′C′;
computing intermediate coordinates of the 2D point M′, assuming this 2D point M′ belongs to one of the three angular sectors, by multiplying the coordinates of the 2D point M′, relatively to the intersection point S, S1 or S2 according to the angular sector by the matrix relative to said angular sector;
if those intermediate coordinates are positive values and if their sum is greater than or equal to 1, then the 2D point M′ belongs to a current angular sector and is not invariant, the 2D point M belongs to a quadrilateral defined from two vertices of the triangle ABC and two vertices of the triangle A_{λ0}B_{λ0}C_{λ0} and the coordinates of the 2D point M are determined as being a weighted linear combination of the coordinates of those four vertices,
otherwise other intermediate coordinates are computed by considering another angular sector.

5. A device comprising a processor configured to apply an inverse-color gamut mapping to color image data representing colors of an original color gamut, characterized in that said inverse-color gamut mapping maps color image data, represented by a 2D point M belonging to a triangle ABC, to a mapped color image data of an output color gamut, said triangle ABC representing the original color gamut in a chromaticity diagram and centred on the white point O of the original color gamut, said mapped color image data of the output color gamut being represented by a 2D point M′ belonging to a triangle A′B′C′ representing the output color gamut in the chromaticity diagram, wherein said inverse-color gamut mapping comprises:
determining a triangle A_{λ0}B_{λ0}C_{λ0} in the chromaticity diagram by applying an homothety to the triangle ABC, said homothety being centered on the white point O and using a scaling factor λ₀, said triangle A_{λ0}B_{λ0}C_{λ0} representing a preserved color gamut in which the color image data remain unchanged;
determining three angular sectors in the chromaticity diagram, each delimited by two lines starting from the white point O and joining one of the vertices A, B or C of the triangle ABC, and computing a 2×2 matrix for each of those three angular sectors according to the triangle ABC;
computing intermediate coordinates of the 2D point M, assuming this 2D point M belongs to one of the three angular sectors, by multiplying the coordinates of the 2D point M by the matrix relative to said angular sector;
if those intermediate coordinates are positive values and if their sum is lower or equal to 1, then the 2D point M belongs to the current angular sector, otherwise other intermediate coordinates are computed by considering another angular sector;
if the 2D point M does not belong to the triangle A_{λ0}B_{λ0}C_{λ0}, the 2D point M belonging to a quadrilateral defined by two vertices of the triangle A_{λ0}B_{λ0}C_{λ0} and two vertices of the triangle A′B′C′, determining the coordinates of the 2D point M′ as being a weighted linear combination of the coordinates of said four vertices, one of the weights of said combination depending on the distance of the 2D point M to a line joining two vertices of the triangle A_{λ0}B_{λ0}C_{λ0} relatively to a line joining the two vertices of the triangle ABC.

6. A device comprising a processor configured to apply a color gamut mapping to color image data representing colors of an output color gamut, characterized in that said color gamut mapping maps mapped color image data, represented by a 2D point M′ belonging to a triangle A′B′C′, to a color image data of an original color gamut, said triangle A′B′C′ representing the output color gamut in a chromaticity diagram, said color image data of the original color gamut being represented by a 2D point M belonging to a triangle ABC representing the original color gamut in the chromaticity diagram, wherein said color gamut mapping comprises:
determining a triangle A_{λ0}B_{λ0}C_{λ0} in the chromaticity diagram by applying an homothety to the triangle ABC, said homothety being centered on the white point of the original color gamut mapping and using a scaling factor λ₀, said triangle A_{λ0}B_{λ0}C_{λ0} representing a preserved color gamut in which the color image data remain unchanged;
determining three angular sectors in the chromaticity diagram, a first, respectively second and third, angular sector being delimited by a first half-line defined by an intersection point S, respectively S1 and S2, and a vertex of the triangle A′B′C′ and a second half-line defined by another vertex of the triangle A′B′C′ and said intersection point S, respectively S1 and S2, said intersection point S, respectively S1 and S2, being defined as the intersection of a first half-line defined by a vertex of the triangle A′B′C′ and a vertex of the triangle A_{λ0}B_{λ0}C_{λ0}, and a second half-line defined by another vertex of the triangle A_{λ0}B_{λ0}C_{λ0} and another vertex of the triangle A′B′C′, and computing a 2×2 matrix for each of those three angular sectors SA, SB and SC according to the triangle A′B′C′;
computing intermediate coordinates of the 2D point M′, assuming this 2D point M′ belongs to one of the three angular sectors, by multiplying the coordinates of the 2D point M′, relatively to the intersection point S, S1 or S2 according to the angular sector by the matrix relative to said angular sector;
if those intermediate coordinates are positive values and if their sum is greater than or equal to 1, then the 2D point M′ belongs to a current angular sector and is not invariant, the 2D point M belongs to a quadrilateral defined from two vertices of the triangle ABC and two vertices of the triangle A_{λ0}B_{λ0}C_{λ0}, and the coordinates of the 2D point M are determined as being a weighted linear combination of the coordinates of those four vertices,
otherwise other intermediate coordinates are computed by considering another angular sector.,

7. A device for encoding color image data, wherein the device comprises a processor configured to apply an inverse-color gamut mapping which maps color image data, represented by a 2D point M belonging to a triangle ABC, to a mapped color image data of an output color gamut, said triangle ABC representing the original color gamut in a chromaticity diagram and centered on the white point O of the original color gamut, said mapped color image data of the output color gamut being represented by a 2D point M′ belonging to a triangle A′B′C′ representing the output color gamut in the chromaticity diagram, wherein said inverse-color gamut mapping comprises:
determining a triangle A_{λ0}B_{λ0}C_{λ0} in the chromaticity diagram by applying an homothety to the triangle ABC, said homothety being centered on the white point O and using a scaling factor λ₀, said triangle A_{λ0}B_{λ0}C_{λ0} representing a preserved color gamut in which the color image data remain unchanged;
determining three angular sectors in the chromaticity diagram, each delimited by two lines starting from the white point O and joining one of the vertices A, B or C of the triangle ABC, and computing a 2×2 matrix for each of those three angular sectors according to the triangle ABC;
computing intermediate coordinates of the 2D point M, assuming this 2D point M belongs to one of the three angular sectors, by multiplying the coordinates of the 2D point M by the matrix relative to said angular sector;
if those intermediate coordinates are positive values and if their sum is lower or equal to 1, then the 2D point M belongs to the current angular sector, otherwise other intermediate coordinates are computed by considering another angular sector;
if the 2D point M does not belong to the triangle A_{λ0}B_{λ0}C_{λ0}, the 2D point M belonging to a quadrilateral defined by two vertices of the triangle A_{λ0}B_{λ0}C_{λ0} and two vertices of the triangle A′B′C′, determining the coordinates of the 2D point M′ as being a weighted linear combination of the coordinates of said four vertices, one of the weights of said combination depending on the distance of the 2D point M to a line joining two vertices of the triangle A_{λ0}B_{λ0}C_{λ0} relatively to a line joining the two vertices of the triangle ABC.

8. A device for decoding color image data, wherein the device comprises a processor configured to apply a color gamut mapping which maps decoded color image data, represented by a 2D point M′ belonging to a triangle A′B′C′, to a color image data of an original color gamut, said triangle A′B′C′ representing the output color gamut in a chromaticity diagram, said color image data of the original color gamut being represented by a 2D point M belonging to a triangle ABC representing the original color gamut in the chromaticity diagram, wherein said color gamut mapping comprises:
determining a triangle A_{λ0}B_{λ0}C_{λ0} in the chromaticity diagram by applying an homothety to the triangle ABC, said homothety being centered on the white point of the original color gamut mapping and using a scaling factor λ₀, said triangle A_{λ0}B_{λ0}C_{λ0} representing a preserved color gamut in which the color image data remain unchanged;
determining three angular sectors in the chromaticity diagram, a first, respectively second and third, angular sector being delimited by a first half-line defined by an intersection point S, respectively S1 and S2, and a vertex of the triangle A′B′C′ and a second half-line defined by another vertex of the triangle A′B′C′ and said intersection point S, respectively S1 and S2, said intersection point S, respectively S1 and S2, being defined as the intersection of a first half-line defined by a vertex of the triangle A′B′C′ and a vertex of the triangle A_{λ0}B_{λ0}C_{λ0}, and a second half-line defined by another vertex of the triangle A_{λ0}B_{λ0}C_{λ0} and another vertex of the triangle A′B′C′, and computing a 2×2 matrix for each of those three angular sectors SA, SB and SC according to the triangle A′B′C′;
computing intermediate coordinates of the 2D point M′, assuming this 2D point M′ belongs to one of the three angular sectors, by multiplying the coordinates of the 2D point M′, relatively to the intersection point S, S1 or S2 according to the angular sector by the matrix relative to said angular sector;
if those intermediate coordinates are positive values and if their sum is greater than or equal to 1, then the 2D point M′ belongs to a current angular sector and is not invariant, the 2D point M belongs to a quadrilateral defined from two vertices of the triangle ABC and two vertices of the triangle A_{λ0}B_{λ0}C_{λ0},and the coordinates of the 2D point M are determined as being a weighted linear combination of the coordinates of those four vertices,
otherwise other intermediate coordinates are computed by considering another angular sector.

9. A computer program product comprising program code instructions to execute the steps of the method of claim 1 when this program is executed on a computer.

10. Non-transitory storage medium carrying instructions of program code for executing steps of the method of claim 1 when said program is executed on a computing device.

11. A computer program product comprising program code instructions to execute the steps of the method of claim 2 when this program is executed on a computer.

12. A computer program product comprising program code instructions to execute the steps of the method of claim 3 when this program is executed on a computer.

13. A computer program product comprising program code instructions to execute the steps of the method of claim 4 when this program is executed on a computer.

14. Non-transitory storage medium carrying instructions of program code for executing steps of the method of claim 2 when said program is executed on a computing device.

15. Non-transitory storage medium carrying instructions of program code for executing steps of the method of claim 3 when said program is executed on a computing device.

16. Non-transitory storage medium carrying instructions of program code for executing steps of the method of claim 4 when said program is executed on a computing device.
